(19) United States
(12) Patent Application Publication
(10) Pub. No.: US 2023/0153981 A1
(43) Pub. Date: May 18, 2023

(54) DETERMINATION OF REQUIRED AMOUNT OF PAINT

(71) Applicant: Comet & Progress Ltd., Shoham (IL)

(72) Inventors: Ron ARAZI, Tel Aviv (IL); Iris SHIMONOV-BENYAMIN, Tel Aviv (IL); Tal LEIZER, Zikhron Ya'akov (IL)

(21) Appl. No.: 17/917,349

(22) PCT Filed: Mar. 15, 2021
(86) PCT No.: PCT/IL2021/050282

§ 371 Date: Oct. 6, 2022

Related U.S. Application Data
(60) Provisional application No. 63/006,318, filed on Apr. 7, 2020.

(51) Int. Cl. G06T 7/00; G06V 10/25; G06V 10/26; G06V 10/88

(52) U.S. Cl. CPC G06T 7/0006; G06V 10/25; G06V 10/26; G06V 10/88; G06T 2207/30252; G06Q 10/063112

(57) ABSTRACT

A system determines an amount of paint required for a painting job. It performs the following: (a) receive an image of a surface, e.g. part of an automobile. The image comprises an indication of a region of the image, including a sub-region of the surface to be painted; (b) receive a user identification of a painter who will perform a painting job; (c) receive an indication of a paint coverage capability associated with the painter; (d) process the image to determine the sub-region; (e) calculate an area of the sub-region; (f) received an indication of a coverage capability of the paint to be utilized in the painting job; (g) determine the amount of paint, based at least on the area of the sub-region and on the painter paint coverage capability; (h) output an indication of the amount of paint required.

### TECHNICAL FIELD

The presently disclosed subject matter relates to painting of surfaces.

### BACKGROUND

When a surface such as automobile parts requires painting, the amount of paint required for the particular painting job is often determined by painters using rough estimation, based on their visual inspection of the surface and on their experience.

GENERAL DESCRIPTION

According to a first aspect of the presently disclosed subject matter there is presented a method of determining an amount of paint required for a painting job, the method comprising, using a processing circuitry to perform the following:

a) receive at least one image of a surface, wherein the image comprises an indication of a region of the image, the region including a sub-region of the surface to be painted;

b) receive a user identification (ID) of a painter who will perform a painting job;

c) receive an indication of a paint coverage capability associated with the painter;

d) process the image to determine the sub-region;

e) calculate an area of the sub-region;

f) determine an amount of paint required for the painting job, based at least on the area of the sub-region and on the paint coverage capability associated with the painter; and

g) output an indication of the amount of paint required.

In addition to the above features, the method according to this aspect of the presently disclosed subject matter can include one or more of features (i) to (xl) listed below, in any desired combination or permutation which is technically possible:
(i) the surface is a surface of at least one part of an automobile.
(ii) the step (a) further comprising receiving an indication of a coverage capability of the paint to be utilized in the painting job, wherein the determining of the amount of paint required being based at least partly on the indication of the coverage capability of the paint.
(iii) the indication of the coverage capability comprises a poor-hider indication.
(iv) the coverage capability of the paint to be utilized being based at least partly on data of past painting jobs associated with a paint color.
(v) the indication of the region comprising a polygon.
(vi) the step (c) comprises, responsive to there being no indication of a paint coverage capability associated with the painter, receiving a default coverage capability parameter, the default coverage capability constituting the indication of the paint coverage capability associated with the painter.
(vii) the step (a) further comprising receiving a method of painting to be utilized in the painting job, wherein the determining of the amount of paint required being based at least partly on the method of painting.
(viii) the method of painting comprises one of: top coat, two steps and three steps.
(ix) the step (a) comprising receiving an indication of a relation between dimensions of the at least one image and dimensions of the surface to be painted, wherein the step (e) comprising determining the relation.
(x) the indication of the relation comprises a reference element comprised in the at least one image, the reference element corresponding to a reference object of defined size,
(xi) step (e) further comprising:
   (A) identify the reference element;
   (B) determining at least one of:
   (i) a ratio between an area of the reference element and an area associated with the sub-region; and
   (ii) a ratio between at least one dimension of the reference element and at least one dimension associated with the sub-region,

wherein the determination of the relation is based on the determination of the step
(xii) the reference element is associated with one of a label and a magnet, which is placed on, or in proximity to, the surface to be painted.
(xiii) the one of a label and a magnet label comprises a QR Code.
(xiv) an area of the reference element is measured in pixels.
(xv) the at least one image is captured by a depth camera, wherein the indication of the relation being based on the depth information associated with the at least one image.
(xvi) the method further comprises: performing the following, prior to the step (a):
   (h) capture the at least one image utilizing at least one imaging sensor; and
   (i) receive user input indicative of the region.
(xvii) the receiving of the user input comprises:
   (i) displaying to the user, via a user interface, the at least one image; and
   (ii) enable the user to indicate on the at least one image, utilizing the user interface, the indication of the region.
(xviii) the user interface comprises a screen.
(xix) the method further comprises: performing the following, prior to the step:
   (j) enable the user to input an indication of a painting method.
(xx) the method further comprises: performing the following, prior to the step (a):
   (k) enable the user to input an indication of a coverage capability of the paint to be utilized in the painting job.
(xxi) the method further comprises: performing the following, prior to the step (a):
   (l) enable the user to input the user identification.
(xxii) the imaging sensor is comprised in a camera.
(xxiii) the step (d) is performed on a composite image comprising multiple images of the at least one image.
(xxiv) the step (d) performed utilizing a segmentation method.
(xxv) the region including at least one sub-region of the surface to not be painted.

wherein the segmentation method excludes, from the sub-region of the surface to be painted, a least one sub-region of the surface to not be painted.
(xxvi) the segmentation method is based on comparing at least one of colors and textures of sections of the at least one image to at least one of a color and a texture of a central section of the at least one image.
(xxvii) the segmentation method comprises an iterative process.
(xxviii) the iterative process comprises:
   (i) selecting a portion of the region as an initial mask;
   (ii) setting the initial mask to constitute an input mask;
   (iii) performing a segmentation process on the input mask, thereby generating an output mask;
   (iv) setting the output mask to constitute an input mask;
   (v) repeating the steps (iii) and (iv) until completing a defined number of iterations;
   (vi) responsive to the completion of the defined number of iterations, determining a relation between an area of the output mask and an area of the region;
   (vii) responsive to the relation between an area of the output mask and an area of the region, being above a defined relation threshold, setting the output mask to constitute the sub-region; and
   (viii) responsive to the relation between an area of the output mask and an area of the region, being below a defined relation threshold, setting the region to constitute the sub-region.
(xxix) the initial mask comprising a polygon.
(xxx) the initial mask is determined using a morphological transformation.
(xxxi) the paint coverage capability associated with the painter being determined utilizing the following method:
   (I) receive data of past painting jobs performed by the painter, wherein the data of the past painting jobs comprising, for each past painting job of the past painting jobs, at least:
      (a) an area of a surface painted; and
      (b) data indicative of an amount of paint utilized;
   (II) for each past painting job, calculate an amount of paint utilized per unit of area of surface painted, based at least on the data indicative of an amount of paint utilized; and
   (III) perform a statistical analysis of the data of the past painting jobs, thereby deriving the paint coverage capability associated with the painter.
(xxxii) the data indicative of an amount of paint utilized comprising an amount of paint allocated to each past painting job and an amount of paint left over from the each past painting job.
(xxxiii) the step (III) comprises ignoring outliers.
(xxxiv) the step (III) utilizes a Chi-squares Distribution.
(xxxv) the paint coverage capability associated with the painter being based on a median associated with the Chi-squares Distribution.
(xxxvi) the data of the past painting jobs further comprising at least one of: a poor-hider indication and a dilution parameter.
(xxxvii) the data of the past painting jobs is associated with a pre-defined number of past painting jobs.
(xxxviii) the pre-defined number of past painting jobs is 10.
(xxxix) the data of the past painting jobs is associated with a most-recent pre-defined number of past painting jobs, wherein the method further comprising, performing after the step (f) the following:
   (m) receiving data indicative of an amount of paint utilized for the painting job; and
   (n) updating the data of the past painting jobs with at least the area of the sub-region, the amount of paint required for the painting job, and the data indicative of the amount of paint utilized for the painting job.
(xl) the device is one of a smartphone, a tablet.

According to a second aspect of the presently disclosed subject matter there is presented a non-transitory computer readable storage medium tangibly embodying a program of instructions that, when executed by a processing circuitry, cause the processing circuitry to perform the following method:

a) receive at least one image of a surface, wherein the image comprises an indication of a region of the image, the region including a sub-region of the surface to be painted;

b) receive a user identification of a painter who will perform a painting job;

c) receive an indication of a paint coverage capability associated with the painter;

d) process the image to determine the sub-region;

e) calculate an area of the sub-region;

f) determine an amount of paint required for the painting job, based at least on the area of the sub-region and on the paint coverage capability associated with the painter; and

g) output an indication of the amount of paint required.

According to a third aspect of the presently disclosed subject matter there is presented a non-transitory computer readable storage medium tangibly embodying a program of instructions that, when executed by a device, the device operatively connected to a processing circuitry, cause the device to perform the following method:

(A) capture at least one image of a surface, utilizing at least one imaging sensor; and

(B) receive user input indicative of a region of the image, the region including a sub-region of the surface to be painted,

wherein the processing circuitry configured to perform the following:

a) receive the region;

b) receive a user identification of a painter who will perform a painting job;

c) receive an indication of a paint coverage capability associated with the painter;

d) process the image to determine the sub-region;

e) calculate an area of the sub-region;

f) determine an amount of paint required for the painting job, based at least on the area of the sub-region and on the paint coverage capability associated with the painter; and

g) output an indication of the amount of paint required.

According to a fourth aspect of the presently disclosed subject matter there is presented a system, comprising a processing circuitry, configured to:

a) receive at least one image of a surface, wherein the image comprises an indication of a region of the image, the region including a sub-region of the surface to be painted;

b) receive a user identification of a painter who will perform a painting job;

c) receive an indication of a paint coverage capability associated with the painter;

d) process the image to determine the sub-region;

e) calculate an area of the sub-region;

f) determine an amount of paint required for the painting job, based at least on the area of the sub-region and on the paint coverage capability associated with the painter; and

According to a fifth aspect of the presently disclosed subject matter there is presented a device configured to perform the following:

(A) capture at least one image of a surface, utilizing at least one imaging sensor; and

(B) receive user input indicative of a region of the image, the region including a sub-region of the surface to be painted,

wherein the device operatively connected to a processing circuitry, the processing circuitry configured to perform the following:

a) receive the region;

b) receive a user identification of a painter who will perform a painting job;

c) receive an indication of a paint coverage capability associated with the painter;

d) process the image to determine the sub-region;

e) calculate an area of the sub-region;

f) determine an amount of paint required for the painting job, based at least on the area of the sub-region and on the paint coverage capability associated with the painter; and

g) output an indication of the amount of paint required.

In addition to the above features, the device according to this aspect of the presently disclosed subject matter can include feature (xli) listed below, in any desired combination or permutation which is technically possible:

(xli) The device of the previous claim, wherein the processing circuitry is in a computer remote to the device.

According to sixth aspect of the presently disclosed subject matter there is presented a method of determining an amount of paint required for a painting job, the method comprising, using a processing circuitry to perform the following:

a) receive at least one image of a surface to be painted, wherein the image comprises an indication of a region of the image, the region including a sub-region of the surface to be painted;

b) process the image to determine the sub-region to be painted,

e) calculate an area of the sub-region;

d) determine the amount of paint required for the painting job, based at least on the area of the sub-region; and

e) output an indication of the amount of paint required.

According to a seventh aspect of the presently disclosed subject matter there is presented a method of determining an amount of paint required for a painting job, the method comprising, using a processing circuitry to perform the following:

a) receive a user identification of a painter who will perform the painting job;

b) receive an indication of a paint coverage capability associated with the painter,

c) receive an area of a sub-region of a surface to be painted,

d) determine the amount of paint required for the painting job, based at least on the area of the sub-region and on the paint coverage capability associated with the painter; and

e) output an indication of the amount of paint required.

The second to seventh aspects of the disclosed subject matter can optionally include one or more of features (i) to (xli) listed above, mutatis mutandis, in any desired combination or permutation which is technically possible.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates schematically an example generalized view of a painting job, in

FIG. 2 schematically illustrates an example generalized view of a reference object, in accordance with some embodiments of the presently disclosed subject matter;

FIG. 3 schematically illustrates an example generalized view of a region, in accordance with some embodiments of the presently disclosed subject matter:

FIG. 4 schematically illustrates an example generalized view of an invalid sub-region, in accordance with some embodiments of the presently disclosed subject matter;

FIG. 5 schematically illustrates schematically illustrating an example generalized view of an identified reference element, in accordance with some embodiments of the presently disclosed subject matter;

FIG. 6 illustrates an example generalized schematic diagram of a paint-amount determination system, in accordance with some embodiments of the presently disclosed subject matter;

FIG. 7 illustrates an example generalized schematic diagram of a device, in accordance with some embodiments of the presently disclosed subject matter;

FIGS. 8A and 8B illustrate one example of a generalized flow chart diagram of a process for determining an amount of paint required for a paint job, in accordance with certain embodiments of the presently disclosed subject matter;

FIG. 9 illustrates one example of a generalized flow chart diagram of a process for determining a sub-region, in accordance with certain embodiments of the presently disclosed subject matter;

FIG. 10 illustrates one example of a sub-region, in accordance with certain embodiments of the presently disclosed subject matter;

FIG. 11 illustrates one example of a generalized flow chart diagram of a process for determining coverage capability of a painter, in accordance with certain embodiments of the presently disclosed subject matter;

FIG. 12 illustrates one example of outlier data, in accordance with certain embodiments of the presently disclosed subject matter; and

FIG. 13 illustrates one example of a statistical distribution, in accordance with certain embodiments of the presently disclosed subject matter.

### DETAILED DESCRIPTION

In the drawings and descriptions set forth, identical reference numerals indicate those components that are common to different embodiments or configurations.

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

Unless specifically stated otherwise, as apparent from the following discussions, it is appreciated that throughout the specification discussions utilizing terms such as “processing”, “receiving”, “calculating”, “determining”, “outputting” or the like, refer to the action(s) and/or process(es) of a computer that manipulate and/or transform data into other data, said data represented as physical, e.g. such as electronic or mechanical quantities, and/or said data representing the physical objects. The term “computer” should be expansively construed to cover any kind of hardware-based electronic device with data processing capabilities including a personal computer, a server, a computing system, a communication device, a smartphone, a tablet, a processor or processing unit (e.g. digital signal processor (DSP), a microcontroller, a microprocessor, a field programmable gate array (FPGA), an application specific integrated circuit (ASIC), etc.), and any other electronic computing device, including, by way of non-limiting example, processing circuitries 630 and 730, disclosed in the present application.

The operations in accordance with the teachings herein may be performed by a computer specially constructed for the desired purposes, or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

The terms “non-transitory memory” and “non-transitory storage medium” used herein should be expansively construed to cover any volatile or non-volatile computer memory suitable to the presently disclosed subject matter.

As used herein, the phrase “for example,” “such as”, “for instance” and variants thereof describe non-limiting embodiments of the presently disclosed subject matter. Reference in the specification to “one case”, “some cases”, “other cases”, “one example”, “some examples”, “other examples” or variants thereof means that a particular described method, procedure, component, structure, feature or characteristic described in connection with the embodiment(s) is included in at least one embodiment of the presently disclosed subject matter, but not necessarily in all embodiments. The appearance of the same term does not necessarily refer to the same embodiment(s) or example(s).

Usage of conditional language, such as “may”, “might”, or variants thereof should be construed as conveying that one or more examples of the subject matter may include, while one or more other examples of the subject matter may not necessarily include, certain methods, procedures, components and features. Thus such conditional language is not generally intended to imply that a particular described method, procedure, component or circuit is necessarily included in all examples of the subject matter. Moreover, the usage of non-conditional language does not necessarily imply that a particular described method, procedure, component or circuit is necessarily included in all examples of the subject matter.

It is appreciated that certain embodiments, methods, procedures, components or features of the presently disclosed subject matter, which are, for clarity, described in the context of separate embodiments or examples, may also be provided in combination in a single embodiment or examples. Conversely, various embodiments, methods, procedures, components or features of the presently disclosed subject matter, which are, for brevity, described in the context of a single embodiment, may also be provided separately or in any suitable sub-combination.

It should also be noted that each of the figures herein, and the text discussion of each figure, describe one aspect of the presently disclosed subject matter in an informative manner only, by way of non-limiting example, for clarity of explanation only. It will be understood that that the teachings of the presently disclosed subject matter are not bound by what is described with reference to any of the figures or described in other documents referenced in this application.

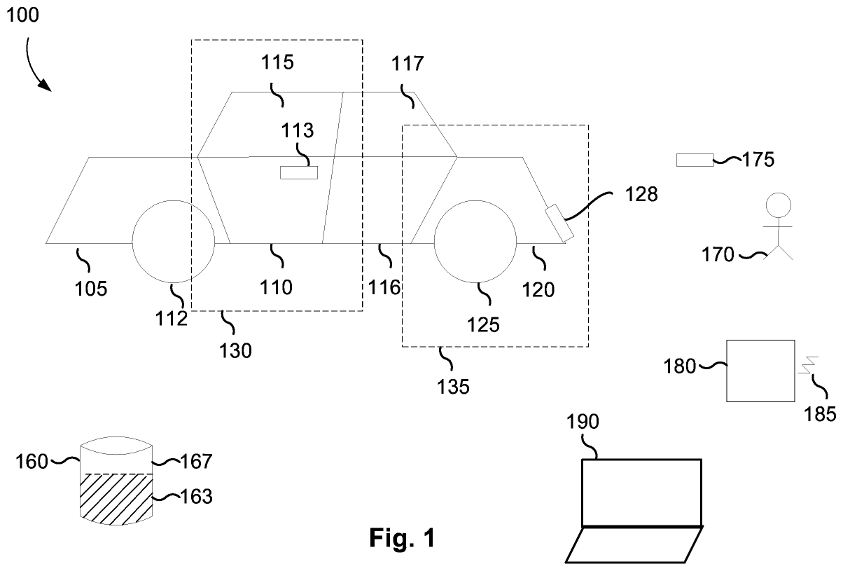

Bearing this in mind, attention is drawn to FIG. 1, schematically illustrating an example generalized view of a painting job 100, in accordance with some embodiments of the presently disclosed subject matter. In some examples, the painting job 110 takes place in a garage.

In the example of the figure, the surface to be painted is one or more parts of an automobile or other vehicle 105. In one example, there is a need to paint all or part of the front door 110. In another example, there is a need to paint all or part of the rear side panel 120. A user 170 of a paint-amount determination system 180, e.g. a painter or other staff member of the garage, captures an image 130, 135 of the relevant surface utilizing a device 175. In some examples, device 175 includes an imaging sensor, e.g. one comprised in a camera, and the imaging sensor is utilized to capture the image. In some non-limiting examples, device 175 is a smartphone, a tablet or a similar user terminal.

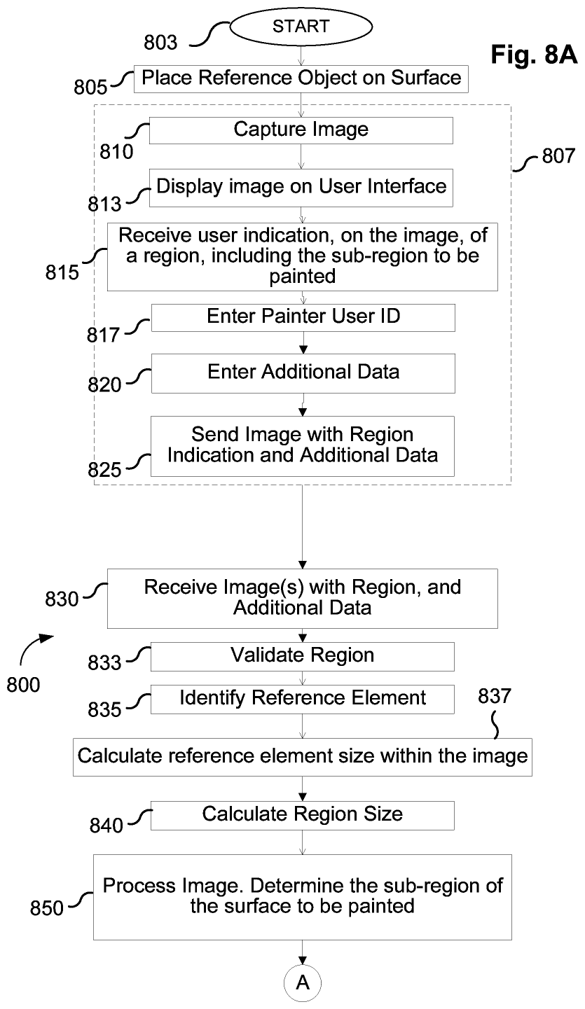

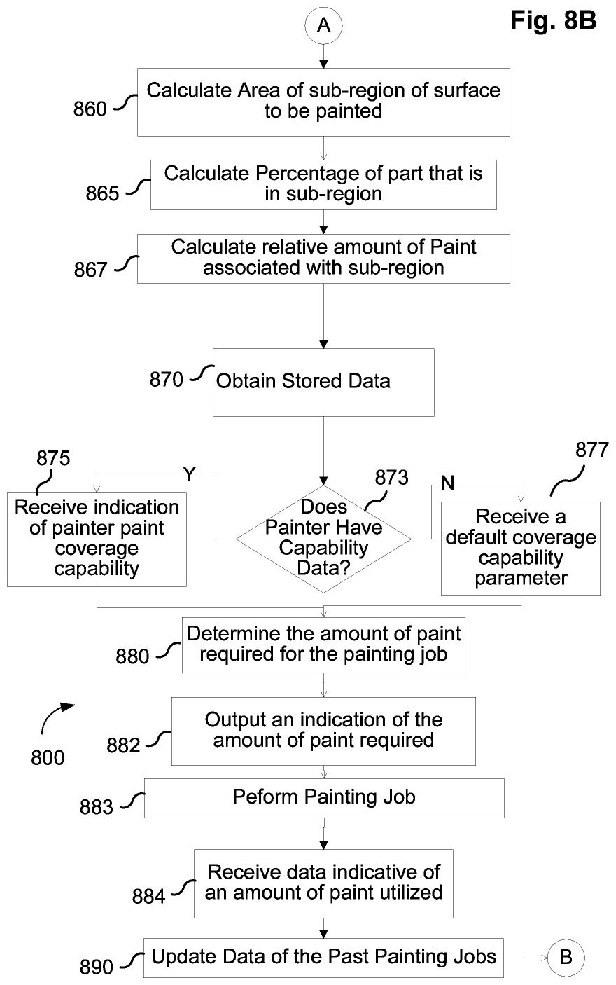

In some examples, device 175 sends the image 130, 135 to a local or remotely-located paint-amount determination system 180, which automatically calculates the amount of paint required for the relevant paint job. An example method for this process, end to end, is disclosed further herein with reference to FIG. 8. System 180 in some examples outputs the amount of paint required to e.g. a display 190, and/or to user device 175.

Example image 130 includes a sub-region of the image corresponding to the surface 110 to be painted. Note that image 130 displays not only the front door 110 to be painted. It also includes other components of the automobile, e.g. parts of front wheel 112, rear window 117 and rear door 116. In addition the image includes components of the automobile that are located within the sub-region 110, but are not to be painted, e.g. door handle 113 and front window 115.

Similarly, example image 135 includes a sub-region of the image corresponding to the surface 120 to be painted. Note that image 135 displays not only the rear side panel 120, that is the surface to be painted. It also includes other components of the automobile, e.g. rear wheel 125, rear bumper 128, and parts of rear window 117 and rear door 116.

Also shown in the figure is an example bucket 160 of paint, containing the amount of paint determined as required, and allocated for the job. The amount of paint used in practice for the paint job is shown as 167. The amount of paint allocated for the job, but not used in practice, is depicted as 163. Amount 163 of paint represents wastage, as in some examples it cannot be used for another paint job, and must be discarded. Note also, that in some cases different painters have different levels of skill and experience. A more skilled and/or experienced painter can in some cases perform a particular paint job, providing a uniform, continuous and complete coverage of the part, of the require quality and with the required coverage of paint, using a smaller amount 167 of paint, and thus less wastage, than does a less skilled and/or experienced painter.

In order to attempt to minimize such wastage, the presently disclosed subject matter presents a method of determining an amount of paint required 163, 167 for a painting job. In some cases, the method can take into consideration the skill level of the particular painter who will perform the job. In some examples, the method includes at least the following steps:

a) receive one or more images 130, 135 of a surface, wherein the image includes an indication of one or more regions of the image, the region(s) including a sub-region that is indicative of the surface 110, 120 to be painted;

b) receive a user identification (ID) of a painter who will perform a painting job;

c) receive an indication of the paint coverage capability associated with the painter;

d) process the image 130, 135 to determine the sub-region(s);

e) calculate an area of the sub-region;

f) determine an amount of paint required 163, 167 for the painting job, based at least on the area of the sub-region, and on the paint coverage capability associated with the painter; and

g) output an indication of the amount of paint required.

In some examples, step (a) further includes receiving an indication of a coverage capability of the paint to be utilized in the painting job, and the determination in step (1) is based at least partly on this indication of the paint's coverage capability. An example of the indication of the coverage capability is a poor-hider indication, disclosed further herein.

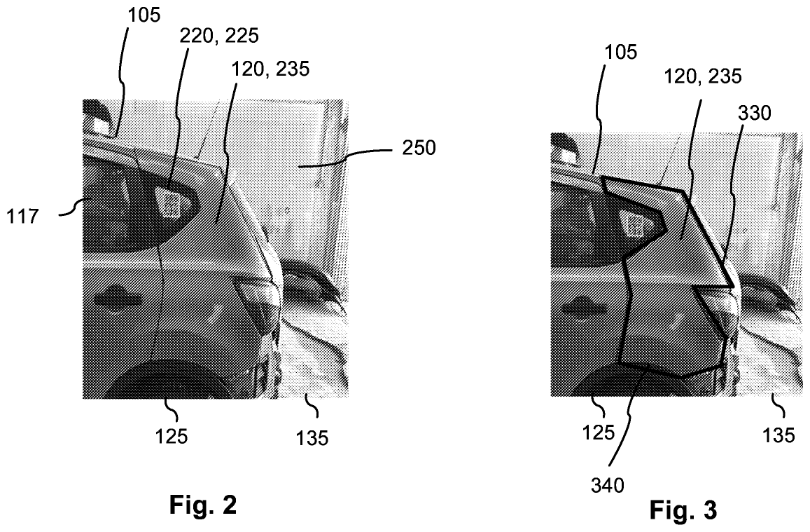

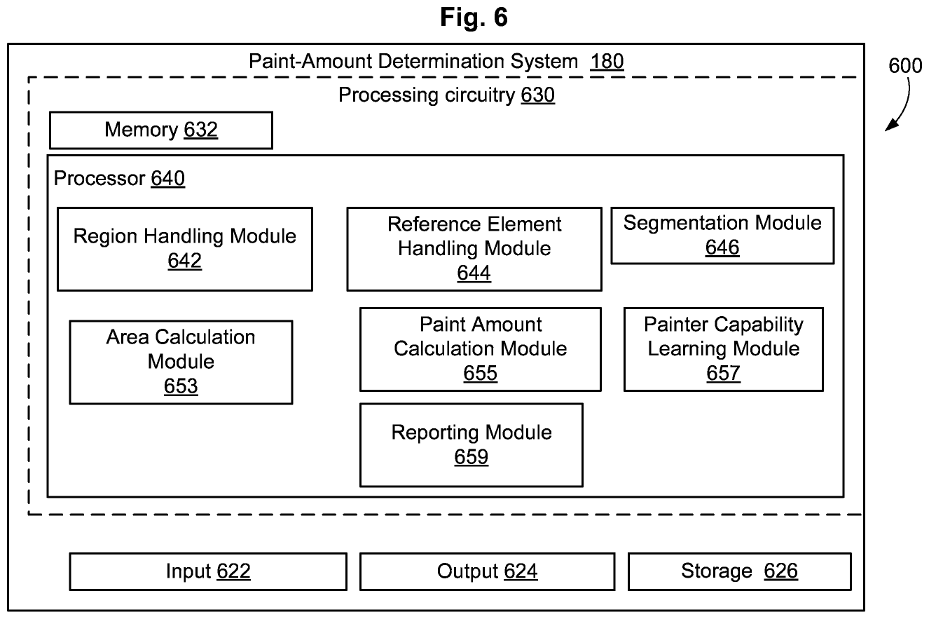

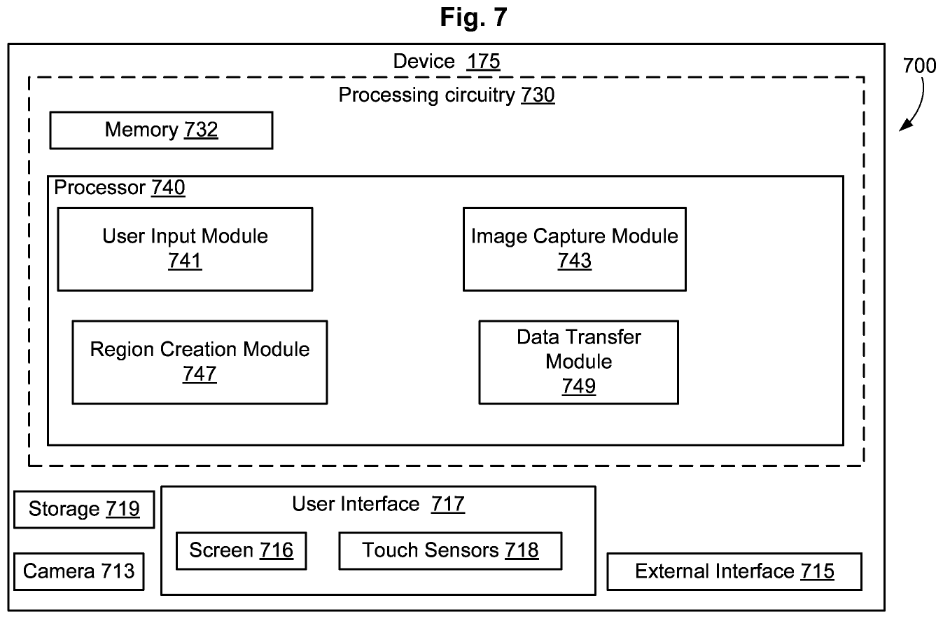

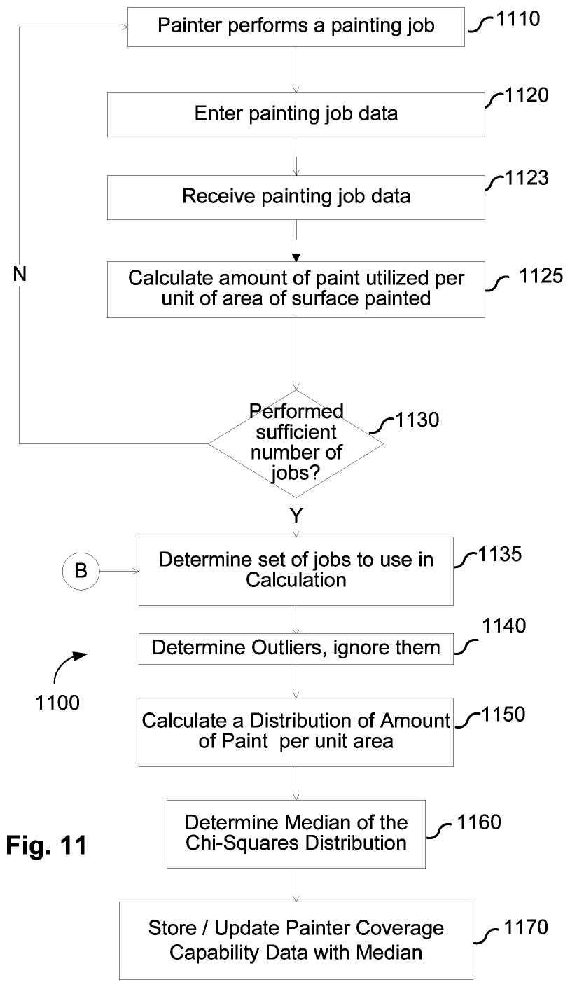

FIGS. 2-5 and 8-10 disclose example methods for indicating the region on the image 130, 135, for calculating the area of the specific surface 110, 120 to be painted, and for calculating the amount of paint required for the painting job, based on processing of the image 130, 135. In some examples, such calculations are capable of excluding portions of the image 130, 135 that correspond to sub-regions of the image that are not to be painted, such as windows 115, 117. FIGS. 11-13 disclose example methods for determining the paint coverage capability associated with a particular painter. FIGS. 6-7 disclose example systems and devices that are capable of performing these methods.

In some examples, such methods can facilitate the reduction of wastage 163 of paint. Example advantages of such methods are also disclosed further herein.

It should also be noted, that automobile-parts surfaces, such as the exterior surface of front door 110, are presented herein for exposition purposes only, as one non-limiting example of a surface to be painted. Another example of such a surface is the wall of a room, where the wall it to be painted, while the windows, doorways and electrical outlets located within the wall are not to be painted. The area of the surface to be painted in such a case does not include the windows etc. An additional example is the surface of an aircraft.

Attention is now drawn to FIG. 2, schematically illustrating an example generalized view of a reference object, in accordance with some embodiments of the presently disclosed subject matter. The figure discloses a depiction of image 135 which includes a depiction of the rear side panel 120 of the automobile 105, which is the surface to be painted by the painter. The sub-region of the image which corresponds to rear side panel 120 is indicated by reference 235. Note that the image 135 does not include only the rear side panel 120, 235, but also additional portions of the car. For example, part of rear wheel 125 is seen, as well as part of rear door window 117. Notice that the image also includes background objects, such as wall 250, that are captured in the image but are not part of the automobile 105.

The image 135 also displays a representation of a reference object 225, e.g. a label or a magnet. In the example of the figure, the label or magnet 225 is of a Quick Response (QR) code. In some examples, user 170 or some other staff member attaches or otherwise places the reference object 225 on the surface of the automobile, whether on the surface 120 to be painted or elsewhere in the field of view of the camera of device 175. For example, the user may place the reference object 225 on another part of automobile 105, in proximity to surface 120 to be painted, and in the field of view of the camera. As will be disclosed with reference to the flow chart of FIG. 8, in some examples the use of reference object 225 can assist the system 180 in determining the area of surface 120, and in compensating for the capture of images by device 175 at varying distances from the surface 120. The representation of the reference object 225 on the image is referred to herein also as a reference element 220 of the image 135.

Other non-limiting examples of a reference object of known size, which can be represented as a reference element 220 in the image, include:
a part of the automobile, e.g. a door handle
a license plate
an inspection sticker on the windshield.
a similar object or element with a pre-known recognisable size

In some examples, the user 170 enters size information (e.g. the length of the door handle) into device 175. In some other examples, size information is stored in the system 180—e.g. the size of door handles per car model, or the size of license plates per country/state. In one case of the later example, the user enters the model of the car to be painted, into the device 175.

Attention is now drawn to FIG. 3, schematically illustrating an example generalized view of a region, in accordance with some embodiments of the presently disclosed subject matter. After capturing the image 135 using an image sensor of device 175, in some examples the device 175 is configured to enable user 170 to receive user input indicative of a region within the image. For example, the device can display the image 135 to the user, utilizing a user interface of the device. In one example, the user interface includes an interactive screen or other display comprised in the device. In some examples, the user is able to indicate the region(s) 330 within the image, utilizing the user interface. In some examples, region 330 is referred to herein also as a Region of Interest (ROI).

The user creation of the region can be done, for example, by touching the screen or other user interface, on the displayed image 135, with their fingers, or with a stylus etc. The user 170 thus interacts with the device or user terminal 175 to provide the input indicative of the region(s) 330.

In the example of the figure, the user is able to mark on the screen a polygon 330, that includes the region 235 corresponding to the surface 120 to be painted. For example, the user touches a number of points on the image, in sequence. The device 175 receives this indication 330, and e.g. constructs the polygon from the points. In some examples, the user can indicate another shape 330, e.g. a circle, oval or rectangle, that includes the surface 120 to be painted. Such simpler shapes may be easier for a user to indicate on the user interface, although they may be less accurate in terms of being a close match to the actual shape and borders of the part 120 to be painted.

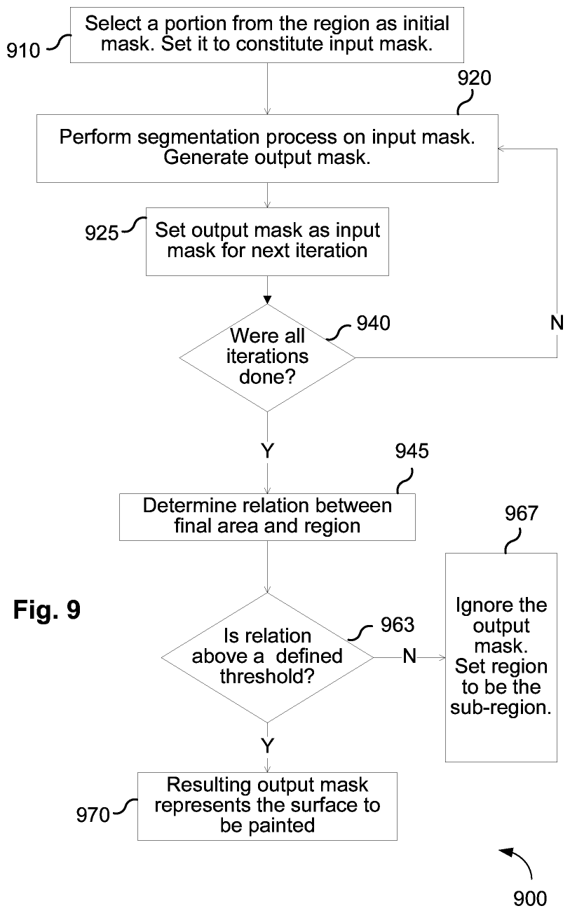

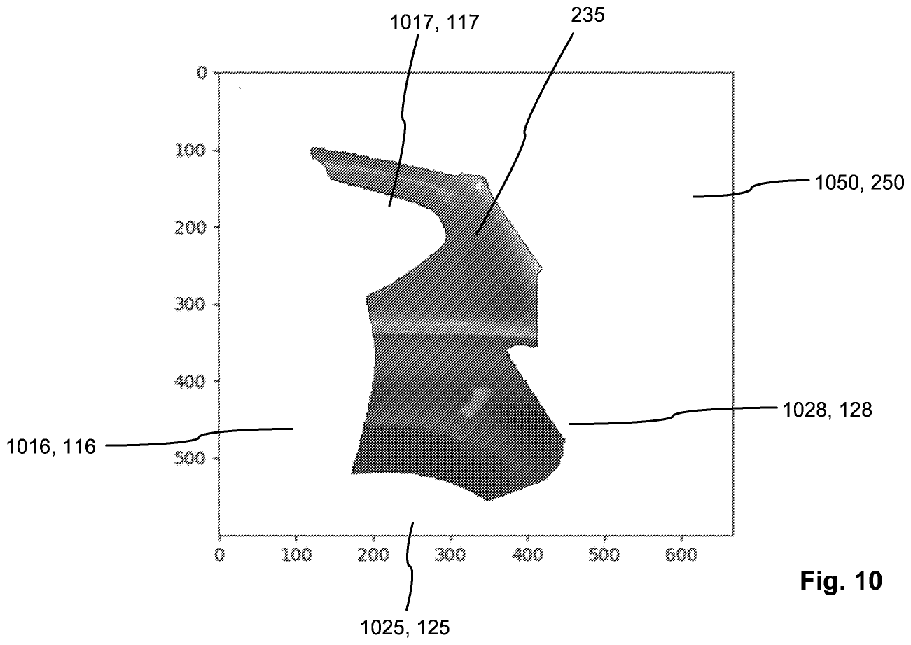

In some examples, region 330 is input so as to roughly correspond to the sub-region 235 of the surface 120 to be painted. Note that since the automobile parts have in some case irregular shapes, a circle or polygon 330 might not correspond exactly to the surface 120 to be painted. For example, in the figure it can be seen that polygon 330 includes a small portion 340 of wheel 125, which is not part of the rear side panel, and thus is not part of the surface to be painted. A sub-region such as 340 is referred to herein also as a sub-region 340 of a surface to not be painted, within the region 330. There will be disclosed further herein, for example with reference to FIGS. 9 and 10, methods to process the image 135 so as to exclude, when determining the sub-region 235 of the surface 120 to be painted, such sub-region(s) 340 of the surface to not be painted.

Note that an indication 330 by a user may in some cases enable system 180 to more accurately calculated the area of the surface 120 of the part to be painted. The image processing applied to image 135 in such cases may be able to focus on the polygon or other such indication 330 of the sub-region, and thus a more efficient processing can be facilitated. Note also that in some cases the user indicated the sub-region in a very accurate manner, and the sub-region 235 is equal to the region 330.

In some examples, the region 330 is referred to herein also as a first portion of image 135, and the sub-region 220 is referred to herein also as a second portion of image 135.

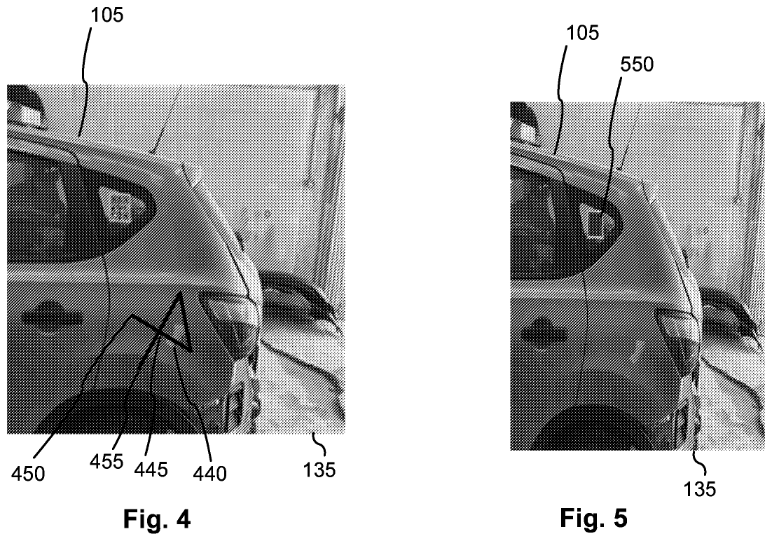

Attention is now drawn to FIG. 4, schematically illustrating an example generalized view of an invalid sub-region, in accordance with some embodiments of the presently disclosed subject matter. In the example, the user 170 has indicated on the image 135, displayed on the screen of device, a polygon 440 that is not valid. Note that the lines cross each other at point 445, and that two points 450, 455 on the left of the shape 440 are not connected. In some examples, the process performed by system 180, as disclosed, for example, further herein with reference to FIGS. 8, will include validation of regions 330, 440, so as to reject invalid regions such as 440.

Attention is now drawn to FIG. 5, schematically illustrating an example generalized view of an identified reference element, in accordance with some embodiments of the presently disclosed subject matter. In some examples, paint-amount determination system 180 identifies, using image processing techniques, the reference element 550 in the image 135, which corresponds to the reference object 225 placed by the user 170 in the field of view of e.g. the camera of device 175. In the examples of FIGS. 2 and 5, the system 180 is configured to identify QR codes, and thus identifies the reference element 220 on the image 135 which corresponds to the QR code label or magnet 225. The identified reference element is indicated in the figure by 550. As disclosed, for example, further herein with reference to FIGS. 8, in some examples system 180 can utilize the identified reference element 550 to determine the dimensions and areas of objects captured in image 135, including those of sub-region 235 corresponding to the surface 120 to be painted.

Before turning to a disclosure of an example process, per FIG. 8, example systems that are capable of performing such a process are disclosed, with reference to FIGS. 6 and 7. Attention is now drawn to FIG. 6, schematically illustrating an example generalized schematic diagram 600 of a paint-amount determination system, in accordance with some embodiments of the presently disclosed subject matter.

In some examples, paint-amount determination system 180 may include a computer. It may, by way of non-limiting example, comprise processing circuitry 630. Processing circuitry 630 may comprise a processor 640 and memory 632. The processing circuitry 630 may be, in non-limiting examples, general-purpose computer(s) specially configured for the desired purpose by a computer program stored in a non-transitory computer-readable storage medium. They may be configured to execute several functional modules in accordance with computer-readable instructions. In other non-limiting examples, processing circuitry 630 may be a computer(s) specially constructed for the desired purposes.

In some examples, processor 640 of processing circuitry 630 is configured to perform at least some of the functionalities disclosed further herein with reference to FIGS. 8, 9 and/or 11. Processor 640 may comprise at least one or more functional modules. In some examples, processor 640 comprises region handling module 642. In some examples, this module is configured to receive indications of regions of the images that are input by user 170, as well as to validate the region shape, e.g. as disclosed with reference to FIG. 4.

In some examples, processor 640 comprises reference element handling module 644. In some examples, this module is configured to identify reference elements 220, corresponding to reference objects 225 such as a QR Code label or magnet, e.g. as disclosed with reference to FIG. 5. In some examples, this module also is configured to determine the size (e.g. dimensions and/or area) of the reference element 220.

In some examples, processor 640 comprises segmentation module 646. In some examples, this module is configured to determining the sub-region 235 of the surface 120 to be painted, based on the region 330, such e.g. as disclosed further herein with reference to FIGS. 9-10. In some other examples, such a determination is performed using a method other than a segmentation method, e.g. using machine learning. In such other examples, module 646 may be replaced by a relevant other functional module, e.g. by a machine learning module (not shown).

In some examples, processor 640 comprises area calculation module 653. In some examples, this module is configured to calculate the area(s) of the surface(s) 120, 110 to be painted. In some examples, this calculation is based on output of segmentation module 646.

In some examples, processor 640 comprises paint amount calculation module 655. In some examples, this module is configured to calculate the amount, quantity, volume or weight of paint required for the painting job, based e.g. on the calculated area of the surface 110, 120 to be painted, which was determined, in some examples, by area calculation module 653. This module can also output the calculated amount.

In some examples, processor 640 comprises painter capability learning module 657. In some examples, this module is configured to learn the paint coverage capability associated with a particular painter, for example using the method as disclosed further herein with reference to FIGS. 11-13. This capability data can be utilized, in some examples, as an input to the paint amount calculation performed by paint amount calculation module 655.

In some examples, processor 640 comprises reporting module 659. In some examples, this module is configured to provide various reports to staff and/or management, for example as disclosed further herein. In some cases, this module outputs the reports via output interface 624 to e.g. display 190. In some cases, the reports user can request reports using display 190 and/or device 175, which communicate with reporting module 659 via input interface 622.

In some examples, memory 632 of processing circuitry 630 is configured to store data utilized during the determination of the amount of paint required for a paint job. For example, it can store the image 135, data associated with the region 330, calculations of area, segmentation process data (as disclosed with reference to FIG. 9), user identification of the painter, coverage capability data associated with the painter etc.

In some examples, paint-amount determination system 180 further comprises input(s) 622. This can in some examples receive inputs from device 175, and/or from external data sources that e.g. store relevant data.

In some examples, paint-amount determination system 180 further comprises output(s) 624. This can in some examples send outputs, such as calculated amounts of paint, and reports, to display 190, which is operatively coupled to system 180. In some examples, display 190 is comprised in system 180. In some examples, display 190 is comprised in device 175, and thus user 170 using the device 175 can receive the output information from outputs 624.

In some examples, paint-amount determination system 180 further comprises storage component(s) 626. This can in some examples store data that is needed for a relatively long term, and/or comparatively large amounts of data. One example of such data is learned paint coverage capabilities associated with each painter. Another non-limiting example is data of past painting jobs performed by the painter, as is disclosed further herein with reference to FIG. 11. Still another example is poor-hider indications associated with various colors, as is disclosed further herein with reference to FIG. 8.

In other examples, there can be a different division of storage between memory 632 and storage 626.

Attention is now drawn to FIG. 7, schematically illustrating an example generalized schematic diagram 700 of a device 175, in accordance with some embodiments of the presently disclosed subject matter. In some examples, device 175 is a user terminal, e.g. a smartphone or tablet.

In some examples, device 175 may include a computer. It may, by way of non-limiting example, comprise processing circuitry 730. Processing circuitry 730 may comprise a processor 740 and memory 732. The processing circuitry 730 may be, in non-limiting examples, general-purpose computer(s) specially configured for the desired purpose by a computer program stored in a non-transitory computer-readable storage medium. They may be configured to execute several functional modules in accordance with computer-readable instructions. In other non-limiting examples, processing circuitry 630 may be a computer(s) specially constructed for the desired purposes.

In some examples, processor 740 of processing circuitry 730 is configured to perform at least certain functionalities disclosed further herein with reference to FIG. 8. Processor 740 may comprise at least one or more functional modules. In some examples, processor 740 comprises image capture module 743. In some examples, this module is configured to capture images 130, 135 that that include a surface 110, 120 to be painted. This module can in some cases utilize an imaging device such as camera 713, which is comprised in device 175. Camera 713 can comprise an imaging sensor (not shown).

This module can in some cases utilize an imaging device such as camera 713, which is comprised in device 175. Camera 713 can comprise an imaging sensor (not shown).

In some examples, processor 740 comprises region creation module 747. In some examples, this module is configured to enable the user 170 to indicate the region 330 of the image 135 that includes the surface 120 to be painted. An example is a user marking the vertices of polygon 330. In some examples, this utilizes user interface 717. An example of this indication is disclosed with reference to FIG. 4.

In some examples, processor 740 comprises user input module 747. In some examples, this module is configured to enable the user 170 to input parameters and other data, relevant for the paint determination. Non-limiting examples of such data include painter User ID, a method of painting to be utilized in the painting job, and an indication of a coverage capability of the paint to be utilized in the painting job. In some examples, this module utilizes user interface 717. Example methods implementing such functionalities are disclosed further herein with reference to FIG. 8.

In some examples, processor 740 comprises data transfer module 749. In some examples, this module is configured to enable the device to transfer the data to other systems, e.g. to system 180 (in a case where system 180 and device 175 are not comprised in the same system. Module 747 can make use of external interface 715, which is comprised in device 175. Example methods implementing such functionalities are disclosed further herein with reference to FIG. 8.

In some examples, memory 732 of processing circuitry 730 is configured to store data utilized during the interaction of user 170 with the device. For example, it can store the image 135, data associated with the region 330, and user input.

In some examples, device 175 further comprises user interface (UI) 717. This can in some examples enable interface with user 170. In some examples, UI 717 includes a screen 716 or other display 716, to display the image 135, user prompts and various entered parameters. In some examples, UI 717 includes touch sensors 718 or other components to react to user interaction with screen 716, and to recognize user input actions.

In some examples, device 175 further comprises storage component(s) 719. This can in some examples store data that is needed for a relatively long term, e.g. images of various automobiles. In other examples, there can be a different division of storage between memory 732 and storage 719.

In some examples, in order to distinguish between the two processing circuitries 630 and 730, they are referred to herein also as first processing circuitry 630 (comprising a first processor 640 and first memory 632) and second processing circuitry 730 (comprising a second processor 740 and second memory 732), respectively.

FIGS. 6 and 7 illustrate only a general schematic of the system architecture, describing, by way of non-limiting example, certain aspects of the presently disclosed subject matter in an informative manner only, for clarity of explanation only. It will be understood that that the teachings of the presently disclosed subject matter are not bound by what is described with reference to FIGS. 6 and 7.

Only certain components are shown, as needed to exemplify the presently disclosed subject matter. Other components and sub-components, not shown, may exist. Systems such as those described with respect to the non-limiting examples of FIGS. 6 and 7 may be capable of performing all, some, or part of the methods disclosed herein.

Each system component and module in FIGS. 6 and 7 can be made up of any combination of software, hardware and/or firmware, as relevant, executed on a suitable device or devices, which perform the functions as defined and explained herein. The hardware can be digital and/or analog. Equivalent and/or modified functionality, as described with respect to each system component and module, can be consolidated or divided in another manner Thus, in some embodiments of the presently disclosed subject matter, the system may include fewer, more, modified and/or different components, modules and functions than those shown in FIGS. 6 and 7. To provide one non-limiting example of this, in some examples the segmentation module 646 and area calculation module 653 can be combined. Similarly, in some examples, there may be a separate input 622 and output 624 for each communication technology (e.g. Wi-Fi, GSM/UMTS, CDMA) supported by device 175 and/or by display 190. Similarly, in some examples, two separate modules can exist instead of Region Creation Module 747— one for displaying the captured image to the user 170, and one for receiving user input to create region 330.

One or more of these components and modules can be centralized in one location, or dispersed and distributed over more than one location, as is relevant. Similarly, in some examples, some or all of the functions disclosed with reference to system 180 can be performed within user device or user terminal 175, and processor 740 could then run some or all of the modules disclosed with reference to processor 640. Alternatively, processing circuitry 630 can be comprised within device 175. Similarly, part of the functions disclosed with reference to device 175 can in some examples be performed by system 180. These same statements apply as well to output display 190.

Each component in FIGS. 6 and 7 may represent a plurality of the particular component, possibly in a distributed architecture, which are adapted to independently and/or cooperatively operate to process various data and electrical inputs, and for enabling operations related to connecting, maintaining and disconnection wireless intercom communication. In some cases, multiple instances of a component may be utilized for reasons of performance, redundancy and/or availability. Similarly, in some cases, multiple instances of a component may be utilized for reasons of functionality or application. For example, different portions of the particular functionality may be placed in different instances of the component.

Communication between the various components of the systems of FIGS. 6 and 7, in cases where they are not located entirely in one location or in one physical component, can be realized by any signaling system or communication components, modules, protocols, software languages and drive signals, and can be wired and/or wireless, as appropriate. The same applies to system interfaces such as 622, 624 and 715.

Attention is now drawn to FIGS. 8A and 8B, illustrating one example of a generalized flow chart diagram of a process for determining an amount of paint required for a paint job, in accordance with certain embodiments of the presently disclosed subject matter. This process 800 is in some examples carried out by systems such as those disclosed with reference to FIGS. 6 and 7. Note that the specific example of FIG. 8 is for a case where user device 175 and system are separate components that are capable of communication with each other. As indicated above, there are other possible arrangements of the system architecture, and in those arrangements the flow would change as appropriate.

The flow starts at 803. According to some examples, user 170 places or attached the reference object 225, e.g. on a surface of automobile 105 (block 805). FIG. 2 shows an example of such a reference object.

According to some examples, user 170 captures image 135 of a surface 110, 120 (block 810). In some examples, this is done using an image sensor of camera 713, and image capture module 743, of device 175. The image includes a depiction of surface 110, 120 to be painted.

According to some examples, image 135 is displayed to the user (block 813). This can be done, for example, by region creation module 747, or by image capture module 743, operatively connected to e.g. screen 716 of user interface 717.

According to some examples, a user indication of region 330 is received (block 815). The indicated region 330 will include the sub-region 235 of the image, corresponding to the surface 120 to be painted. This can be done, for example, by region creation module 747, operatively connected to e.g. touch sensors 718 of user interface 717. In some examples, the touch sensors are comprised in screen 716. In some examples, e.g. as disclosed with reference to FIG. 3, the input by the user 170 of the indication of the region 330 is the marking or drawing of a polygon 330. Blocks 813 and 815 thus enable the user to indicate, on the at least one image, the indication of the region 330.

According to some examples, a user ID of the painter who will do the job is received (block 817). This can be done, for example, by user input module 741 of device 175, operatively connected to e.g. touch sensors 718 of user interface 717. In some examples, the user input is enabled as follows: a prompt is displayed on screen 716, and the user 170 enters the user ID in response to the prompt. Note that in some examples, this block is performed before steps 810 or 815.

According to some examples, additional data is received (block 820). This can be done, for example, by user input module 741 of device 175, operatively connected to e.g. touch sensors 718 of user interface 717. In some examples, a prompt is displayed on screen 716, and the user 170 enters the data in response to the prompt. Non-limiting examples of such data include an indication of a coverage capability of the paint to be utilized in the painting job, and method of painting to be utilized in the painting job.

In some examples, the coverage capability of the paint is indicated by the user, by providing an indicator that the particular paint color/shade/pigment to be used is a poor-hider—e.g. checking off “poor hider=Yes”. A poor hider is a paint pigment that has a low ability to cover a particular surface area, and for which relatively a larger amount of paint is required to provide good coverage of the surface. In other examples, the user inputs the particular paint color to be used, and device 175 or system 180 will match the color to coverage capability/poor-hider information, associated with the color, that is stored in memory 632 or 732, and/or in storage or 626 or 719.

Non-limiting examples of the method of painting include: top coat, two steps and three steps.

In some examples, user 170 can also input into device 175 an indication whether or not blending will be used in the paint job. For example, in some cases the painter is to paint the repaired or replace rear door 116, but also wishes to perform blending painting on portions of front door 110 and rear side panel 120. In some cases, the user 170 can also input into device 175 other associated data, for example an indication of the area(s) to receive blending painting. An example of such an indication is indicating a second sub-region(s) (e.g. second a polygon) that includes the areas to receive blending. As will be disclosed further herein, in some cases this information will be used to account for the blending, when calculating the required amount of paint.

According to some examples, the image, along with the indication of the region and the additional data, is sent (block 825). This can be done, for example, by device 175, sending this information using data transfer module 749 and external interface 715. In the example of the flow, the data is sent to system 180.

In some examples, blocks 810-825 are performed by user device 175. This is indicated in the figure by the dashed-line box 807 surrounding the blocks.

According to some examples, the image, along with the indication of the region and the additional data, are received (block 830). This can be done, for example, by Paint-Amount Determination System 180, receiving this information using input 622. In the example of the flow, the data is received from device 175.

According to some examples, the received region 330, 440 is validated (block 833). This can be done, for example, by region handling module 642. An example of this is disclosed above with reference to FIG. 4. If the region is not of a valid geometric shape, in some cases it will not be possible to perform image processing on it so as to derive the sub-region 235. In some examples, if the region is determined to be invalid, the user 170 will be prompted to enter a new indication of the region. Note also, that in some examples, block 833 can be performed after block 815.

According to some examples, the reference element 220, corresponding to reference object 225 of a defined size, is identified (block 835). This can be done, for example, by reference element handling module 644. An example of this is disclosed above with reference to FIG. 5.

According to some examples, the size of the identified reference element 220, within the image, is calculated (block 835). This can be done, for example, by reference element handling module 644. In this example, it assumed that the reference object 235 is known to have a defined size of 10 cm×20 cm, and this information is stored in e.g. storage 626. In one example, the dimensions of reference element 220 are determined—e.g. 10 pixels by 20 pixels on the image 135. In another example, the area of reference element 220 is determined—e.g. measuring an area of 200 pixels occupied by reference element 220 on the image 135. Assume, in the example, that the image is 1000 pixels by 1000 pixels.

In some examples, based on this information, the module can then determine at least one of the following:
(i) a ratio between at least one dimension of the reference element (e.g. 10 pixels height) and at least one dimension associated with the image 135 (e.g. 1000 pixels height).
(ii) a ratio between the area of the reference element (e.g. 200 pixels) and the area associated with the image (1,000,000 pixels).

According to some examples, the size of the region 330 is calculated (block 840). This can be done, for example, by area calculation module 653, or by reference element handling module 644. In some examples, the area of the region 330 can be determined, e.g. in terms of pixels. Since the ratio between the reference element 220 and image 135, in terms of their dimensions and/or areas, is known, the corresponding ratio between reference element 220 and region 330 can be determined. For example, if the 10 cm×20 cm reference object 225 appears on the image as a reference element 220 of 10×20 pixels, this provides a calibration of image 135 that can enable the determination of the size of region 330.

In this sense, the receiving at system of image 135 that includes reference element 220 can be considered as receiving an indication of the relation between dimensions of the image 135 and dimensions of the surface 120 to be painted.

Calculations such as those performed with reference to steps 835-840 can provide some example advantages. The distance between the camera 713 and the imaged surface (e.g. the automobile parts 110, 120) can in some cases vary from image. For example, if a small door 120 is photographed from close up, the door may look larger in image 135, compared to e.g. an image of a larger door 120 which was photographed from far way. There is thus in some cases a need to compensate for these varying distances, in order to arrive at a correct calculation of the surface 120 to be painted.

Use of reference objects 225 and reference elements 220 is thus one method to solve this potential problem with the calculation. Another non-limiting example of a solution is the use of a depth camera 713. In such a case, the indication of the relation between the reference element 220 and the region 330 can be based on the depth information associated with the image 135 captured by the depth camera.

Note that in some examples one or more of steps 835-840 can be performed after the following step, block 850.

It should also be noted that the surface 120 itself is in some case not flat. A car door, for example, has a certain curvature. In some cases, the curvature is not expected to increase the area calculation substantially, and thus can be ignored. In some examples, such a curvature changes the area of surface 120 by 1% or less.

In some other examples, where a part has a relatively large curvature, e.g. a rear bumper which has surfaces on the sides of the car as well as the rear, the user 170 may capture multiple images 135, so as to account for all of the surface to be painted. In such a case, the system 180 may consider these multiple images when determining the area of the surface to be painted.

According to some examples, the image is processed, to determine the sub-region 235 associated with the surface 120 to be painted (block 850). This can be done, in some examples, by segmentation module 646 of processing circuitry 630. In some examples, the region 330 includes one or more sub-regions associated with surfaces 340 to not be painted. An example of this is the portion 340 of rear wheel 125 which is included in region 330, but is not in the sub-region 235 corresponding to the surface to be painted 120, e.g. the rear side panel. Other example parts that are not part of the part to be painted include windows, mirrors, door handles, lights etc. In such a case, the process of block 850 excludes, from the sub-region 235 of the surface 120 to be painted, the one or more sub-regions 340 of the surface to not be painted. An example output of this block is disclosed further herein, with reference to FIG. 10.

In some examples, this block is performed on a composite image that comprises multiple captured images. This may occur, for example, where the surface to be painted is too large to capture in one image of the camera 713. Another example is where the full paint job is to be performed on several parts or surfaces, e.g. on the front and rear doors as well as on the rear side panel. Still another example is capturing image(s) of certain parts to receive full painting, and capturing image(s) of other parts to receive blending. The creation of the composite image is in some cases performed using known per se techniques.

In other examples where multiple images were captured, the image processing of block 850 is performed separately on each image, and then, as part of the calculation of the surface area to be painted (block 860, below), the areas determined for each image are summed to yield an aggregate area to be painted. In some examples, module 646 utilizes a segmentation method to perform the image processing. This is in some cases a known per se segmentation method. In some examples, the segmentation method is based on comparing color(s) and/or texture(s) of sections of the image(s) 135 to color(s) and/or texture(s) of a central section of the image(s). Such a method can identify the borders of sub-region 235. In some other examples, where filler is used as part of the repair process of e.g. an automobile part, portions of the surface to be painted are expected to have different colors from each other.

In some examples, the segmentation method comprises an iterative process. An example detailed flow of such a method is disclosed further herein, with reference to FIG. 9.

Other techniques to perform block 850 are possible. For example, a machine learning process can be used, e.g. using a neural network, to teach system 180 to distinguish between the region(s) 235 corresponding to the surface 120 to be painted, and sub-region(s) 340 of the surface to not be painted. In such a case, some of the modules of processor 640 would be different, as appropriate.

According to some examples, the area of the sub-region 235, associated with the surface 120 to be painted, is calculated (block 860). This can be done, in some examples, by areas module 653 of processing circuitry 630. In one example, the number of pixels that comprise sub-region 235 is multiplied by a surface-area-per-pixel value that was derived in blocks 837 or 840.

According to some examples, the percentage of entire part area that is within the sub-region 235 is calculated (block 865). This can be done, in some examples, by areas module 653. For example, the user 170 may have indicated or marked, in block 815, a polygon or other shape that includes only half of rear door 120, since only that region of the door is to be painted. Block 860 would compare sub-region 235 to the representation of the entire door 120 on image 135, and would determine that only half of the door area is to be painted.

According to some examples, the relative amount of paint that is associated with sub-region 235 is calculated (block 867). This can be done, in some examples, by paint amount calculation module 655. In such a case, module 653 can retrieve from storage 626 a part-specific paint amount parameter, that is a paint amount (e.g. weight/mass or volume) parameter associated, for example, with the particular part 120. An example data record for a part-specific paint amount parameter can be “Rear Door, Manufacturer X, Car Model Y, Year of Model 2013, color=red #34: 400 milliliters of paint”. In some examples, these records can be input to the storage based on various rules of thumb in the industry. In other examples, the garage or company inputs the information based on history data that was accrued for the particular model/part/color. Note that in some examples of using part-specific paint amount parameters, the user 170 inputs into device 175 the part type, model, year, and paint color, as required. As will be disclosed further herein, in some examples the color is important, as different colors may require different amounts to cover the same area.

In the example disclosed herein, since sub-region 235 comprises only half of the door, the rule of thumb would yield that only 200 milliliters of paint is required for this job.

According to some examples, the additional stored data is obtained (block 870). This can be done, in some examples, by paint amount calculation module 655, retrieving data from storage 626. Non-limiting example stored data to be retrieved include the following:
(a) The base or default amount of paint required per unit of surface area, i.e. an amount-of-paint-per-surface-area parameter (e.g. expressed in millilitres or grams per square meter).
(b) Factors or parameters related to the coverage capability of the paint. For example, there may be a global poor-hider coverage parameter, with e.g. a value of 1.1, indicating that poor-hider paints require 10% more paint than non-poor-hiders. In another example, each poor-hider pigment has its own data. For example, red #34 requires 10% more paint than non-poor-hiders, while blue #55 requires 15% more paint, for a given surface area.
(c) Factors or parameters related to the density or specific gravity of the pigment. For example, certain paint pigments have a higher specific gravity than do others, and thus painting a certain number of grams on a surface will require a different number of millilitres than is required by the other pigments.
(d) Factors or parameters related to the input paint method. For example, if the paint method is two steps, the factor may be e.g. 1.8, indicating that such a method required 1.8 times the amount of paint required, for a given surface area, compared to the top coat method.
(e) Factors or parameters related to blending. For example, areas to receive blending painting rather than full painting can in some cases require a smaller amount of paint per surface area to be painted. The mixture of pigments that are required for a particular paint color or shade. For example, red #34 may be composed of 90% red #6 and 10% yellow #23.
(f) The predicted coverage capability associated with the particular painter who corresponds with the user-input User Identification. For example, the skilled and experienced painter Andy may use in his paint jobs only 90% of the average, typical, or rule-of-thumb amount used by painters, while the less-skilled and/or less-experienced Bob may use 15% more than the average. FIGS. 11-13 disclose an example method for deriving such coverage capability data for a particular painter, based on a history of painting jobs. For some painters, there may be no such data available, or the history data available may be insufficient to provide a painter-specific indication of coverage ability (e.g. fewer than ten (10) past paint jobs were performed). For such a painter, a global or default coverage capability parameter may be stored, that characterizes e.g. the ability of the “typical” painter or of the “above-average” painter”.

Note that the example numbers, and color identities, disclosed above were chosen merely for simplicity of exposition.

According to some examples, a determination is made whether there is coverage ability data stored for the painter associated with the input user ID (block 873). This can be done, in some examples, by paint amount calculation module 655. In response to such data existing, for example in storage 626, the module can receive the indication of the painter's coverage capability (block 875). In response to such data not existing, the module can receive the default coverage capability parameter (block 877).

According to some examples, the amount of paint required for the job is calculated (block 880). This can be done, in some examples, by paint amount calculation module 655. The calculation is based at least on the area of sub-region 235, which was calculated in block 860. In some examples, one or more of the following factors are also included in the calculation:
A. The base or default amount of paint required per unit of surface area.
B. The coverage capability associated with the particular painter (or the default coverage capability parameter, if no painter-specific coverage capability parameter is available).
C. The factors or parameters related to the coverage capability of the particular paint/shade.
D. The factors or parameters related to the pigments' specific density.
E. The factors or parameters related to the painting method.
F. The factors or parameters related to blending, if relevant.

In one simplified exemplary calculation, based on volume of paint, 2 square meters of surface×200 milliliters per square meter×80% David's coverage capability×1.1. for red #34 color×1.8 for two steps method=634 milliliters for the paint job. Similar calculations can be performed based on weight/mass of paint, rather than on volume.

In some examples, instead of using the base or default amount of paint required per unit of surface area, the method utilizes the part-specific paint amount parameter, and the relative area of the sub-region 235 as compared to the entire part 220—as disclosed with reference to blocks 865 and 867. Blocks 865 and 867 are thus optional, and some methods of paint amount calculation do not require that they be performed,

In some examples, a determination is also made of the required amount of each pigment that is associated with the relevant color/shade.

In some examples, a check is performed on the amount of paint, against an expected value for a surface of that area. If the calculated amount is e.g. above this expected value, in some cases it may be determined that the calculation is erroneous.

According to some examples, the amount of paint required for the job is output (block 882). This can be done, in some examples, by paint amount calculation module 655, utilizing output 624, and outputting the information to display 190. In some examples, the output information can also include the amount of each pigment associated with the relevant color/shade. For example, the output can be “1 Liter of red #34 are required. The mixture of pigments is 0.9 liters of red #6 and 0.1 liters of yellow #23”. (In other examples, the units are e.g. grams, instead of milliliters or liters.) Such an option may be relevant in a case where the user 170 input of data, to device 175, included an input of the color/shade/pigment to be utilized in the painting job, e.g. “Red #6”.

According to some examples, the particular paint job is performed by the painter (block 883).

According to some examples, data indicative of the amount of paint actually utilized in practice for the job is received (block 884). This can be done, in some examples, by painter capability learning module 657. In some cases, the painter, after completion of the paint job in block 883, indicates the amount of paint 167 actually utilized, or alternatively indicates the amount of paint 163 remaining in the container 160 after the job is completed. This information can be provided, for example, by typing into device 175, or by photographing the partly-full container 160, for example a container with markings that indicate levels of paint remaining. In other examples, more accurate methods are used, such as a sensor located in the container, or weighing the partly-full container on a scale.

According to some examples, data of past painting jobs is updated (block 890). This can be done, in some examples, by painter capability learning module 657, updating e.g. storage 626. This step in as input “B” into the painter capability learning method disclosed further herein with reference to FIG. 11.

In some other examples, the method may utilize only a part of the above flow. For example, in a case where the sub-region 235 and the area of surface 120 is a priori known, and image processing is not required to derive it from region 330, the flow can start from 865, and calculate paint amount based on area of the part and e.g. coverage capability data associated with the painter, coverage capability parameters associated with the color/shade/pigment and/or the painting method. Also, depending on whether depth information is known, use of a reference object 225 is in some cases not needed—and thus blocks 835-837 are not needed. Similarly, in a case where there is no history data of past painting jobs for painters, or where user ID of painters is not provided or known blocks 873 and 875 can be skipped, and paint amount calculations can be performed based on default coverage capability parameters.

Attention is now drawn to FIG. 9, illustrating one example of a generalized flow chart diagram of a process for determining a sub-region, in accordance with certain embodiments of the presently disclosed subject matter. This process 900 is in some examples carried out by systems such as those disclosed with reference to FIGS. 6 and 7. For example, the flow can be carried out, in some examples, by segmentation module 646 of processor 640 of paint-amount-determination system 180. Flow 900 is a non-limiting example detailed implementation of block 850 of FIG. 8A, utilizing a segmentation method.

In some examples, the segmentation method utilized comprises an iterative process, rather than performing segmentation once.

The example flow starts at 910. According to some examples, a portion of the region 330 is selected as an initial mask (block 910). In some examples, the initial mask is determined using a morphological transformation, e.g. erosion. In some examples, the initial mask comprises a polygon. In some examples, the selected portion is substantially smaller than the region 330 e.g. having an area that is 10% or 30% of the area of the region. In some examples, this portion is located approximately at the center of the region 330. In one example, the center of the initial mask portion and the center of the region are off by up to 10% of the region. In another example, the center of the initial mask portion and the center of the region are off by up to 5% of the region. In some examples, this provides a relatively high probability that pixels in the initial mask correspond to part of the surface 120 to be painted, and thus that much of the initial mask corresponds to part of the surface 120.

In some examples, this a part-specific paint amount parameter portion is referred to herein also as a third portion, to distinguish it from region 330 and sub-region 235.

This initial mask is set to constitute the initial value of the input mask.

According to some examples, a segmentation process is performed on the input mask, (block 920). In some examples, an output mask is generated by this segmentation process.

According to some examples, the output mask is set to constitute the input mask for the next iteration (block 925).

According to some examples, a determination is made, whether the defined number of iterations of the process were performed (block 940). In some examples, this defined number of iterations is a fixed number. Responsive to determining that the defined number of iterations of the process were not performed, the process loops back to block 920.

According to some examples, responsive to determining that the defined number of iterations of the process were performed, a relation, between the area of the output mask and the area of the region 330, is determined (block 945). In some examples, the relation is the ratio of the two areas.

According to some examples, a determination is made whether the relation is above, or possibly equal to, a defined threshold (block 963).

According to some examples, responsive to determining that the relation is above, or in some cases equal to, the defined relation threshold, the output mask is set to constitute the sub-region 235 (block 970). In some examples, after completion of the iterations, the output mask at least roughly corresponds to the part 120 be painted

According to some examples, responsive to determining that the relation is below, or some cases equal to, the defined relation threshold, the output mask is ignored (block 967). The entire region 330 is set to constitute sub-region 235.

Attention is now drawn to FIG. 10, illustrating one example of a sub-region, in accordance with certain embodiments of the presently disclosed subject matter. The figure depicts an example output of performing a method such as block 850 and/or flow 900 on e.g. image 135 of FIG. 3.

It can be seen that all of the portions of image 135 that do not correspond to surface 120 have been removed or excluded, by the image processing. Only sub-region 235, corresponding to surface 120, remains Image portions 1016, 1017, 1028, 1050, corresponding to door 116, window 117, bumper 128 and background 250 have been excluded from sub-region 235. Similarly, image sub-region 1025, corresponding to part 340 of rear wheel 125, although it is part of indicated polygon region 330, does not appear in FIG. 10, since the process of block 850 and/or flow 900 removed it from sub-region 235. The sub-region 235 more closely corresponds to the actual surface 120 to be painted then does image 135 or indicated region 320. This, in some examples, enables improvement in the accuracy of the calculation of the area of part 120—and thus enables improvement in the accuracy of the calculation of the required amount of paint.

Attention is now drawn to FIG. 11, illustrating one example of a generalized flow chart diagram of a process for determining coverage capability of a painter, in accordance with certain embodiments of the presently disclosed subject matter. This process 1100 is in some examples carried out by systems such as those disclosed with reference to FIGS. 6 and 7. For example, most blocks of the flow can be carried out, in some examples, by painter capability learning module 657 of processor 640 of paint-amount-determination system 180.

The process in some examples involves gathering history data of past painting jobs performed by a particular painter, and performing analysis on the data to determine the coverage capability of the painter. According to some examples, the painter performs a particular painting job, on a particular surface, e.g. on one or more automobile parts (block 1110). In some examples, there is at least some uniformity between jobs, e.g. similar parts, parts of similar automobile models, surfaces of similar sizes, similar painting methods and/or similar colors/shades/pigments of paint, with or without blending. In other examples, the jobs vary widely from each other in terms of these parameters.

According to some examples, the painter or other user 170 inputs data associated with the performed painting job (block 1120). In some examples, the data is entered via user device 175. Non-limiting examples of data items input for each job include the following:

(a) date/time information associated with the job

(b) an area of the surface 110, 120 that was painted

(c) painter User ID

(d) the painting method used (top coat etc.)

(e) color/shade information associated with the paint

(f) coverage capability information associated with the paint color/shade, e.g. a poor-hider parameter or other indication

(g) dilution information or parameters, associated with the dilution of the paint used in the job

(h) whether or not there was blending, and associated data

(i) data indicative of the amount of paint or other material utilized.

Some of these input data can be optional. For example, in some cases the color/shade information is not entered. Similarly, in some cases, the system has stored coverage capability information associated with the particular color, and thus the user need not enter a poor-hider parameter or similar information.

In some examples, the data indicative of the amount of paint utilized is the amount 167 of paint that was actually used in the job. In some other examples, the user inputs the amount 160 of paint allocated to the job, and the amount 163 of paint left over from the job. As already indicated, in some examples the amount of paint left over from the job can instead be determined by photographing the partly-full container 160, for example a container with markings that indicate levels of paint remaining in the container. In other examples, more accurate methods are used, such as a sensor located in the container, or weighing the partly-full container on a scale. In a case where the input includes the amount 160 of paint allocated to the job, and the amount 163 of paint left over from the job, the amount 167 actually used is derived from these amounts, after accounting for dilution data, if any.

In some examples, if the painting job involved applying several layers to the surface, some of the data input may be layer-specific data. For example, the user can input data indicative of the amount of paint utilized for layer 1, data indicative of the amount of paint utilized for layer 2, and data indicative of the amount of varnish utilized for a varnish layer. Note that each layer can require a different volume of paint, given the same weight of paint, and vice versa, due to possibly-different specific gravities associated with different pigments.

According to some examples, the input data of the painting job performed by the painter is received (block 1123). In some examples, the data is received in painter capability learning module 657 of system 180.

According to some examples, a calculation is performed, of the amount of paint utilized per unit of area of surface 110, 120 painted (block 1123). The units can be, for example, grams or milliliters per square centimeter. This information, along with data received by the system 180 in block 1123, is in some cases stored, e.g. in storage 626. This calculation makes use of the received data.

According to some examples, a determination is made, whether or not data has been received for a sufficient number of performed past painting jobs, to enable generation of a painter-specific coverage capability (block 1130). In some examples, a pre-defined number of past painting jobs is required to enable the generation. In some examples, this number is ten (10) past painting jobs. In response to determination of receipt of data of an insufficient number of jobs, the flow loops back to 1110, waiting for the painter to perform his or her next job. Note that iterative performance of blocks 1110-1125 causes the system 180 to receive data for each past painting job of the past painting jobs performed by the painter, and to calculate an amount of paint utilized per unit of area of surface painted for each past painting job.

According to some examples, in response to determination that data of a sufficient number of jobs has been received, the flow continues to block 1135. In some examples, the set of past painting jobs to use in calculation of a painter-specific coverage capability is chosen (block 1135).

For example, given an example value of 10 painting jobs as the pre-defined number, the 10 jobs may be defined to be the set of jobs to be used in the analysis. In some cases, a determination may be made whether additional jobs have been performed, and whether a new calculation should be performed that utilizes data of the additional jobs. In some cases, the data of the past painting jobs to be used in the statistical analysis is associated with the most-recent pre-defined number of past painting jobs (e.g. the most recent 10 jobs), where certain older jobs are not considered in the calculation. This is indicated in the figure by reference B, coming from block 890 of FIG. 8B, in which the stored history data of past painting jobs is updated with data of the most-recently-completed painting job. An example of such data is data indicative of the amount of paint utilized for the most-recently-completed painting job (e.g. which was received by user input, e.g. as shown in block 1120), and at least the area of the sub-region 235 corresponding the surface 120 that was painted in the most-recently-completed painting job.

In some other examples, the original 10 (or other pre-defined number of) jobs are used for the statistical analysis, and the additional more-recent jobs are not considered. In still other examples, the original 10 samples, as well as all newer jobs data, are used for the statistical analysis.

In some examples, a statistical analysis of the data of the selected set of past painting jobs is performed. A statistical model of the painter's performance is generated.

According to some examples, an optional first steps is to identify and determine outlier data points, and to ignore them—that is, leave them out of the statistical analysis (block 1140). In some examples, identification of outliers is performed using per se known techniques.

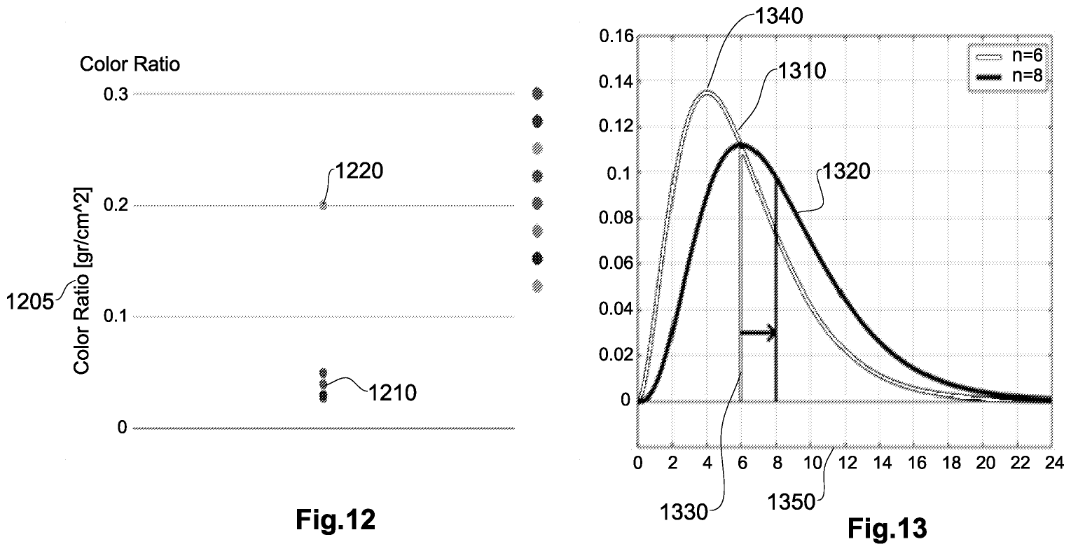

Before continuing with a description of block 1150, attention is first drawn to FIG. 12, illustrating one example of outlier data, in accordance with certain embodiments of the presently disclosed subject matter. The figure depicts data points for several jobs performed by one painter, where the Y axis 1205 represents the ratio of amount of paint actually used per unit area (e.g. square cm) of surface painted. It can be seen that the three data points 1210 are comparatively close in value, while data point is an outlier, having a value of paint-to-area-ratio that is in a clearly different range from those of data points 1210. In the example of the figure, data point 1220 may be ignored when performing the remaining steps of the statistical analysis. In some examples, such an outlier data point is indicative of a performance that is not typical of the particular painter.

Reverting now to FIG. 11, in some examples a distribution of the parameter “amount of paint used per unit area” (paint-to-area-ratio) is calculated, using e.g. known per se statistical techniques (block 1150). In some examples, a Chi-squares distribution is utilized for the calculation.

According to some examples, e.g. in the case of a Chi-squares distribution, the median value of the distribution is calculated, using statistical techniques (block 1160). More detail is disclosed further herein with reference to FIG. 13.

According to some examples, e.g. in the case of a Chi-squares distribution, the median value of the distribution is assigned to be the coverage capability associated with the painter (block 1170). The paint coverage capability associated with the painter has thereby been derived. This parameter is in some cases stored in storage 626. In the case where a previous value of the coverage capability parameter exists in storage, and a new calculation has been performed to account for more recent painting jobs (see e.g. reference B), the stored values of the coverage capability parameters are in some cases updated.

Attention is drawn to FIG. 13, illustrating one example of a statistical distribution, in accordance with certain embodiments of the presently disclosed subject matter. The figure discloses the example of a Chi-squares distribution. Curves 1310, 1320 represent distribution curves for two different values of Degrees of Freedom. The X axis 1350 in this example is the amount of paint per unit area of surface. Line 1330 indicates a median of a curve.

In some examples, there are at least certain example advantages to performing the statistical analysis using a Chi-squares distribution. The Chi-squares distribution is asymmetrical, and is for non-negative values of X (i.e. paint-amount-per-area). In some examples, the expected amount of paint per unit area required by the painter will be at the mode of the distribution.

In such a distribution, the median 1330 will always be greater or equal to the mode 1340. By choosing the median 1330 to be the value of the painter-specific coverage capability parameter, a factor of safety is introduced, in that the painter-specific coverage capability parameter will be at least somewhat larger than the mode. Note that the painter's use of paint, in the job to be performed with reference to FIG. 1, will have certain variation from job to job, and he or she will not use exactly the expected amount. Therefore, by recommending the median parameter instead of, for example, the mode, a paint amount that is in some cases too much will be recommended, instead of a paint amount that is in some cases too little. There is thus high confidence that there will not be a shortage of paint for the job. In some examples, it is preferable for some paint to be left over 163, and for there to be some degree of wastage, then to recommend the painter to use a too-small volume or weight of paint, and have e.g. the mixed paint run out in mid-job.

On the other hand, in some examples selecting the mean value of the distribution, to be the coverage capability, can lead to recommendation of any overly-large amount of paint.

By comparison to a Chi-squares distribution, in some examples the use of e.g. a normal distribution is less appropriate for the method 1100. A normal distribution, for example, will also yield negative values, and is symmetrical, which in some cases may prevent convergence over time.

It should also be noted, that as more data on implemented paint jobs is gathered, in some examples this can facilitate improvement in the accuracy of the parameters that are stored in storage 626 and are used e.g. in block 880. As a non-limiting example, as more historical data is gathered of the actual utilization of red #34 paint in various jobs, as compared to the recommended amount determined for those jobs, an analysis of this data can provide an improved coverage capability parameter associated with that particular color/shade/pigment of paint. In this sense, the coverage capability of the paint to be utilized in calculating the required paint amount is in such cases based at least partly on data of past painting jobs associated with the particular paint color/shade/pigment. In some cases, these re-calculated parameters are more accurate than initially-configured values which are based on rough estimates and on rules of thumb.

In some examples, a system such as system 180 is configured to provide various reports to staff and/or management, e.g. utilizing reporting module 659 of processor 640.

Non-limiting examples of data that can in some cases appear in the reports include:
A) Tables and/or graphs of the number of paint jobs performed per time interval (day, week etc.):
   a. Painting jobs data:
      i. total jobs
      ii. jobs per painter—e.g. average per day—as well as comparison with other painters, e.g. those of comparable experience, those in the same region etc.
      iii. reports per garage/site, per region or company-wide—including number of jobs at site, broken down by painter. Comparisons within a site, and across sites.
   b. amounts of paint used:
      i. e.g. total used, per day. week etc.
      ii. total used per garage/site
      iii. amount used per painter—e.g. average per day—as well as comparison with other painters, e.g. those of comparable experience, those in the same region, average amount used per job etc.
      iv. reports per garage/site, per region or company-wide—including amount used at site, e.g. broken down by painter. Comparisons within a site, and across sites.
   c. alerts of amounts of paint used at a site, as an input for e.g. sales force.

Non-limiting methods of outputting and providing such reports and data include:
A) Mailing reports to site owner/manager/company owner on e.g. a daily/weekly/monthly basis.
B) Seeing a dashboard of the data on screen 716 of user device 175.
C) Generating and viewing reports via a management interface such as display 190.
D) Painters seeing reports on their performance (number of jobs, surface area covered, paint amounts used—e.g. via a dashboard of device 175. Including history of personal performance over time, comparison with other painters and site averages etc.

In some cases, use of method and systems such as those disclosed herein has at least some or all of the following example advantages, compared to at least some traditional methods of calculating a required amount of paint.

Firstly, in some current methods, the amount of paint required is determined by the painter or other staff member, based on a visual inspection by a human, their past experience and possibly various rules of thumb used in that shop or in the industry in general. Such methods by definition are very rough and approximate, and have the risk of yielding the mixing of too much paint, thus causing wastage, or the mixing of too little paint. Note that using too much paint on a surface can also result in a poor paint job. An automated method that calculates exact areas for each part or surface to be painted can thus provide a more accurate use of paint and varnish materials. Also, in some cases the calculation can be performed more quickly.

Secondly, in some examples of the presently disclosed subject matter, a user interface is provided for user 170 on a device 175, enabling the user to capture images and indicate sub-regions to be painted, as well as enabling input of other relevant data, so as to facilitate the calculation of the required paint amount.

Thirdly, in some examples of the presently disclosed subject matter, the surface to be painted is determined, based on the indicated regions, using methods that exclude surfaces that are not to be painted. This further enables accurate calculation of the surface to be painted, and thus accurate calculation of the required paint amount. Also, as disclosed above, an iterative segmentation process can in some cases provide a more accurate determination of sub-region 235.

Fourthly, in some examples of the presently disclosed subject matter, a determination is based on the coverage capabilities of individual painters, for example by examination of the history of past jobs. This can enable a more accurate calculation of paint requirements, as compared to a method which does not differentiate between the skill and experience levels of each painter. For each painter, an accurate amount of paint per unit of surface area can be determined. Furthermore, as disclosed for example further herein with reference to FIG. 11, the coverage capabilities of individual painters can in same cases be adjusted over time, as additional paint jobs are performed. This can enable the determination of up to date coverage capabilities of the individual painters, that reflect possible changes in performance in recent painting jobs, as well as characterize the painter based on an increasingly large number of jobs. Note that the presently disclosed method also takes into account unknown painters, and those without sufficient paint job history data.

Fifthly, in some examples of the presently disclosed subject matter, a determination is based at least partly on the coverage capabilities of specific pigments and consideration of poor hider pigments, as well as consideration of specific gravities of pigments and consideration of possible use of blending. This gives a more accurate calculation of the required paint amount, as compared to methods that consider all colors and pigments to require the same amount of paint per surface area.

Sixthly, in some examples of the presently disclosed subject matter, a determination is based at least partly on the specific painting method to be use for the job. This again gives a more accurate calculation of the required paint amount.

Seventhly, in some examples of the presently disclosed subject matter, the calculation of surface area, and thus the calculation of the required paint amount, account for depth characteristics of the image 135, and for the distance from which the image was captured—again enabling more accurate calculations. In some examples, use of reference objects 235 can facilitate such accuracy, without requiring the use of possibly relatively expensive equipment such as depth cameras.

Eighthly, in some examples of the presently disclosed subject matter, the learning of the painters' coverage capability uses techniques such as a Chi-squares distribution, which in some cases yields a median that provides a relatively safer estimate of a painter's coverage capability

Ninthly, in some examples of the presently disclosed subject matter, reporting functionalities, such as those disclosed further herein, are provided to allow management or the relative staff to, for example, have better knowledge of comparative performance, efficiency and productivity of each painter, track and manage inventory, monitor costs expended on materials and wastage etc.

Note that the above descriptions of process 700, 900, 1100 are non-limiting examples only.

In some embodiments, one or more steps of the flowcharts exemplified herein may be performed automatically. The flow and functions illustrated in the flowchart figures may for example be implemented in systems 175, 180, 190 and in processing circuitries 630, 730, and may make use of components described with regard to FIGS. 6 and 7. It is also noted that whilst the flowchart is described with reference to system elements that realize steps, such as for example systems 175, 180, 190, and processing circuitries 630, 730, this is by no means binding, and the operations can be carried out by elements other than those described herein.

It is noted that the teachings of the presently disclosed subject matter are not bound by the flowcharts illustrated in the various figures. The operations can occur out of the illustrated order. One or more stages illustrated in the figures can be executed in a different order and/or one or more groups of stages may be executed simultaneously. For example, steps 833 and 835, shown in succession, can be executed substantially concurrently, or in a different order. As another example, block 817 can be performed before blocks 810 or 815. Similarly, some of the operations or steps can be integrated into a consolidated operation, or can be broken down to several operations, and/or other operations may be added. As one non-limiting example, in some cases blocks 837 and 840 can be combined.

In embodiments of the presently disclosed subject matter, fewer, more and/or different stages than those shown in the figures can be executed. As one non-limiting example, certain implementations may not include blocks 865, 867.

In the claims that follow, alphanumeric characters and Roman numerals, used to designate claim elements such as components and steps, are provided for convenience only, and do not imply any particular order of performing the steps.

It should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the spirit of the presently disclosed subject matter.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter may be, at least partly, a suitably programmed computer. Likewise, the presently disclosed subject matter contemplates a computer program product being readable by a machine or computer, for executing the method of the presently disclosed subject matter or any part thereof. The presently disclosed subject matter further contemplates a non-transitory machine-readable or computer-readable memory tangibly embodying a program of instructions executable by the machine or computer for executing the method of the presently disclosed subject matter or any part thereof. The presently disclosed subject matter further contemplates a non-transitory computer readable storage medium having a computer readable program code embodied therein, configured to be executed so as to perform the method of the presently disclosed subject matter.

Those skilled in the art will readily appreciate that various modifications and changes can be applied to the embodiments of the invention as hereinbefore described without departing from its scope, defined in and by the appended claims.

1-46. (canceled)

47. A method of determining an amount of paint required for a painting job, the method comprising, using a processing circuitry to perform the following:
a) receive at least one image of a surface, wherein the image comprises an indication of a region of the image, the region including a sub-region of the surface to be painted;
b) receive a user identification (ID) of a painter who will perform a painting job;
c) receive an indication of a paint coverage capability associated with the painter;
d) process the image to determine the sub-region;
e) calculate an area of the sub-region;
f) determine an amount of paint required for the painting job, based at least on the area of the sub-region and on the paint coverage capability associated with the painter; and
g) output an indication of the amount of paint required.

48. The method of claim 47, wherein the surface is a surface of at least one part of an automobile.

49. The method of claim 47, wherein at least one of the following is true:
(I) the step (a) further comprising receiving an indication of a coverage capability of the paint to be utilized in the painting job, wherein the determining of the amount of paint required being based at least partly on the indication of the coverage capability of the paint; and
(II) the coverage capability of the paint to be utilized being based at least partly on data of past painting jobs associated with a paint color.

50. The method of claim 49, wherein at least one of the following is true:
a. the indication of the coverage capability comprises a poor-hider indication.
b. the indication of the region comprising a polygon.

51. The method of claim 47, wherein the step (a) further comprising receiving a method of painting to be utilized in the painting job, wherein the determining of the amount of paint required being based at least partly on the method of painting.

52. The method of claim 47, wherein the step (a) comprising receiving an indication of a relation between dimensions of the at least one image and dimensions of the surface to be painted, wherein the step (e) comprising determining the relation.

53. The method of claim 52, wherein the indication of the relation comprises a reference element comprised in the at least one image, the reference element corresponding to a reference object of defined size,
wherein the step (e) further comprising:
(A) identify the reference element;
(B) determining at least one of:
(i) a ratio between an area of the reference element and an area associated with the sub-region; and
(ii) a ratio between at least one dimension of the reference element and at least one dimension associated with the sub-region,
wherein the determination of the relation is based on the determination of the step (B).

54. The method of claim 53, wherein the reference element is associated with one of a label and a magnet, which is placed on, or in proximity to, the surface to be painted.

55. The method of claim 47, wherein at least one of the following is true:
(I) the method further comprises: performing the following, prior to the step (a):
(h) capture the at least one image utilizing at least one imaging sensor; and
(i) receive user input indicative of the region;
(II) the method further comprises: performing the following, prior to the step (d):
(j) enable the user to input an indication of a painting method.
(III) the method further comprises: performing the following, prior to the step (a):
(k) enable the user to input an indication of a coverage capability of the paint to be utilized in the painting job.
(IV) the method further comprises: performing the following, prior to the step (a):
(l) enable the user to input the user identification.

56. The method of claim 47, wherein the step (d) performed utilizing a segmentation method,
wherein the region including at least one sub-region of the surface to not be painted,
wherein the segmentation method excludes, from the sub-region of the surface to be painted, a least one sub-region of the surface to not be painted.

57. The method of claim 56, wherein at least one of the following is true:
(I) the segmentation method is based on comparing at least one of colors and textures of sections of the at least one image to at least one of a color and a texture of a central section of the at least one image; and
(II) the segmentation method comprises an iterative process.

58. The method of claim 57, wherein the iterative process comprises:
(i) selecting a portion of the region as an initial mask;
(ii) setting the initial mask to constitute an input mask;
(iii) performing a segmentation process on the input mask, thereby generating an output mask;
(iv) setting the output mask to constitute an input mask;
(v) repeating the steps (iii) and (iv) until completing a defined number of iterations;
(vi) responsive to the completion of the defined number of iterations, determining a relation between an area of the output mask and an area of the region;
(vii) responsive to the relation between an area of the output mask and an area of the region, being above a defined relation threshold, setting the output mask to constitute the sub-region; and
(viii) responsive to the relation between an area of the output mask and an area of the region, being below a defined relation threshold, setting the region to constitute the sub-region.

59. The method of claim 58, wherein at least one of the following is true:
i. the initial mask comprising a polygon.
ii. the initial mask is determined using a morphological transformation.

60. The method of claim 47, wherein the paint coverage capability associated with the painter being determined utilizing the following method:
(I) receive data of past painting jobs performed by the painter, wherein the data of the past painting jobs comprising, for each past painting job of the past painting jobs, at least:
(a) an area of a surface painted; and
(b) data indicative of an amount of paint utilized;
(II) for the each past painting job, calculate an amount of paint utilized per unit of area of surface painted, based at least on the data indicative of an amount of paint utilized; and
(III) perform a statistical analysis of the data of the past painting jobs, thereby deriving the paint coverage capability associated with the painter.

61. The method of claim 60, wherein at least one of the following is true:
(i) the data indicative of an amount of paint utilized comprising an amount of paint allocated to the each past painting job and an amount of paint left over from the each past painting job;
(ii) the step (III) comprises ignoring outliers;
(iii) the step (III) utilizes a Chi-squares Distribution;
(iv) the data of the past painting jobs further comprising at least one of: a poor-hider indication and a dilution parameter.
(v) the data of the past painting jobs comprises layer-specific data.
(vi) the data of the past painting jobs is associated with a pre-defined number of past painting jobs.

62. The method of claim 61, wherein the paint coverage capability associated with the painter being based on a median associated with the Chi-squares Distribution.

63. The method of claim 60, wherein the data of the past painting jobs is associated with a most-recent pre-defined number of past painting jobs, wherein the method further comprising, performing after the step (f) the following:
(m) receiving data indicative of an amount of paint utilized for the painting job; and
(n) updating the data of the past painting jobs with at least the area of the sub-region, the amount of paint required for the painting job, and the data indicative of the amount of paint utilized for the painting job.

64. A non-transitory computer readable storage medium tangibly embodying a program of instructions that, when executed by a processing circuitry, cause the processing circuitry to perform the following method:
a) receive at least one image of a surface, wherein the image comprises an indication of a region of the image, the region including a sub-region of the surface to be painted;
b) receive a user identification of a painter who will perform a painting job;
c) receive an indication of a paint coverage capability associated with the painter;
d) process the image to determine the sub-region;
e) calculate an area of the sub-region;
f) determine an amount of paint required for the painting job, based at least on the area of the sub-region and on the paint coverage capability associated with the painter; and
g) output an indication of the amount of paint required.

65. A system, comprising a processing circuitry, configured to:
a) receive at least one image of a surface, wherein the image comprises an indication of a region of the image, the region including a sub-region of the surface to be painted;
b) receive a user identification of a painter who will perform a painting job;
c) receive an indication of a paint coverage capability associated with the painter;
d) process the image to determine the sub-region;
e) calculate an area of the sub-region;
f) determine an amount of paint required for the painting job, based at least on the area of the sub-region and on the paint coverage capability associated with the painter; and
g) output an indication of the amount of paint required.
